(19) United States
(12) Patent Application Publication
(10) Pub. No.: US 2004/0146638 A1
(43) Pub. Date: Jul. 29, 2004

(54) Process for repairing coatings

(76) Inventors: Harald Kloeckner, Lindlar (DE); Guenter Berschel, Koeln (DE); Christian Woessner, Wermelskirchen (DE); Andrew Duda, Gladbeck (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/716,804

(22) Filed: Nov. 18, 2003

Related U.S. Application Data
(60) Provisional application No. 60/434,047, filed on Dec. 17, 2002.

(51) Int. Cl. B05D 3/02; B05D 1/36; B05D 1/02

(52) U.S. Cl. 427/140; 427/307; 427/385.5; 427/421; 427/407.1

(57) ABSTRACT

A process for repairing a multi-layer coating of a substrate, in particular, vehicles having a blemished area, comprising the following successive steps:

A) optionally, preparing the blemished area in a conventional manner,

B) sanding the blemished area and the transitional zone between the blemished area and the intact existing coating,

C) optionally, cleaning the sanded surface (=repair surface),

D) applying a pigmented water-based or solvent-based base coat onto the sanded and optionally cleaned repair surface and fading out into the areas of the intact existing coating,

E) applying the two-component aqueous clear coat based on an OH-functional binder and a polyisocyanate crosslinking agent at conventional spraying viscosity onto the base coat,

F) fading out into the areas of the intact existing coating, which border the surface coated with the base coat, with the aqueous clear coat material, wherein the aqueous clear coat in step F) exhibits the same spraying viscosity as the aqueous clear coat applied in step E) or alternatively after step C),

E1) applying a two-component aqueous pigmented one-layer top coat based on an OH-functional binder and a polyisocyanate crosslinking agent at conventional spraying viscosity onto the repair surface,

F1) fading out into the areas of the intact existing coating which border the repair surface with the aqueous pigmented one-layer top coat material, wherein the aqueous pigmented one-layer top coat in step F1) exhibits the same spraying viscosity as the aqueous pigmented one-layer top coat applied in step E1),

G) curing the resultant coating comprising base coat and clear coat and optionally,

H) sanding the cured coating and polishing the sanded area.

### PRIORITY

This application claims priority from Provisional U.S. Patent Application Serial No. 60/434,047 filed Dec. 17, 2003, incorporated herein by reference.

### FIELD OF THE INVENTION

The invention relates to a process for repairing coatings with aqueous clear or aqueous pigmented one-layer topcoats, which process is in particular useful for the spot repair of vehicles coated with multi-layer coatings.

### DESCRIPTION OF RELATED ART

In the repair of vehicle coatings, water-based coatings are also being increasingly used for environmental reasons. However, the coatings formed using aqueous coating compositions do not in all respects achieve the high quality levels of conventional solvent-based coatings. Numerous attempts accordingly have been made to eliminate or at least mitigate the disadvantages of water based coatings, for example, by developing suitable binders and tailoring making these coatings. Attempts also have been made to modify application parameters, such as, spray nozzle parameters or the sequence of application of the individual coating layers in order, for example, to improve the visual appearance of a coating based on aqueous coating compositions.

Another factor is that in the repair of vehicle coatings, it is often only parts of an automotive body or relatively small blemished areas within a vehicle component that need to be repaired. It is important in such cases to coat the vehicle part or blemished area in such a manner so that there are no differences in color shade or special effect or any other optically perceptible differences relative to the surrounding existing coating.

Various blending-in methods already have been developed in order to be able to obtain optically perfect repair coatings having a very good quality. WO-A-95/14540 (U.S. Pat. No. 5,871,809) accordingly describes a repair coating process, which is intended to avoid clouding of a repair coating, in particular, clouding of a water-based special effect coating. The aqueous base coat is applied in at least two spray passes, preferably without an intermediate flash-off time between the spray passes, in each case until a boundary of the existing coating is reached. This procedure is repeated until the entire part to be coated is provided with the base coat.

EP-A-719 185 describes a repair coating process in which an opaque coat of an aqueous base coat is applied onto the blemished area in single spray pass and, when applying the base coat onto the areas of the existing coating bordering the blemished area, the spray gun is inclined obliquely towards the blemished area and a normal or moderately reduced spray gun input pressure is used to blend in the base coat with the existing coating.

However, methods for applying aqueous base coats, which are generally physically drying systems, cannot be transferred to the application of two-component water-based clear coats in a straight forward manner.

Accordingly, when two-component (two-pack) aqueous clear coats and pigmented one-layer aqueous topcoats are used, difficulties are encountered with achieving acceptable results when attempting to blend-in the surface of the existing coating with the coating being applied and when the resulting coatings are polished. Similarly, known methods for blending-in conventional solvent-based two-pack clear coats or two-pack top coats cannot be transferred to aqueous coatings. One method for blending-in repair coatings that use conventional two-pack top coats, for example, involves coating the repair zone with the two-pack top coat in the conventional manner and blending-in the transition zone to the existing coating using reduced pressure and a more highly thinned coating material. The more highly thinned coating material is produced, for example, by mixing 5 parts by volume of a thinner with one part by volume of the coating material (application information, Standox painting systems, S9.2 blending-in with two-pack top coat, Spot Repair; 12/98). If the latter-stated method is used for blending-in with aqueous clear coats or aqueous top coats, edge marks and a reduction in gloss are, for example, observed, some time after application and curing.

Hitherto, it has not been possible to satisfactorily remedy the above-stated disadvantages. In the past, repair coatings of adequate quality could only be achieved with aqueous clear coats and aqueous top coats only when complete vehicles or vehicle parts are extensively recoated or completely recoated. There is a need for a process in which a vehicle repair coating of an aqueous clear coating or an aqueous top coating will result in the blending-in of such a coating with the existing coating on a vehicle to form an acceptable repair.

### SUMMARY OF THE INVENTION

The present invention provides a process for the repair of a multi-layer coated substrate, in particular, vehicles having a multi-layer coating, which makes it possible to blend in and polish aqueous two-component clear coats and pigmented aqueous two-component one-layer top coats to form a multi-layer repair coating with satisfactory quality that is in line with customer requirements.

In the process of this invention, a multi-layer coating of a substrate, in particular, vehicles coated with a multi-layer coating, having a blemished area within the surface of the multi-layer coating is repaired with an aqueous clear coating by blending-in the clear coating within the surface of the multi-layer coating, comprising the following successive steps:

A) optionally, preparing the blemished area on the substrate to be coated in a conventional manner,

B) sanding the blemished area and the transitional zone between the blemished area and the intact existing coating,

C) optionally, cleaning the sanded surface (=repair surface),

D) applying a pigmented water-based or solvent-based base coat onto the sanded and optionally cleaned repair surface and fading out into the areas of the intact existing coating, which border the repair surface, with the base coat material,

E) applying the two-component aqueous clear coat based on an OH-functional binder and a polyisocyanate crosslinking agent having free isocyanate groups at conventional spraying viscosity onto the base coat,

F) fading out into the areas of the intact existing coating, which border the surface coated with the base coat, with the aqueous clear coat material, wherein the aqueous clear coat in step F) exhibits the same spraying viscosity as the aqueous clear coat applied in step E),

G) curing the resultant coating comprising base coat and clear coat at temperatures of e.g. below 80° C. and optionally,

H) sanding the cured coating and polishing the sanded area.

The invention alternatively relates to a process for the repair of multi-layer coated substrates, in particular vehicles, with a blemished area within a surface of the multi-layer coating, wherein the repair is performed with pigmented one-layer aqueous top coats by means of blending-in within the surface, said repair coating comprising the following successive steps:

A) optionally, preparing the blemished area on the substrate to be coated in conventional manner,

B) sanding the blemished area and the transitional zone between the blemished area and intact existing coating,

C) optionally, cleaning the sanded surface (=repair surface),

D1) applying the pigmented, two-component one-layer aqueous top coat based on an OH-functional binder and a polyisocyanate crosslinking agent having free isocyanate groups at conventional spraying viscosity onto the sanded and optionally cleaned repair surface,

E1) fading out into the areas of the intact existing coating, which border the repair surface, with the one-layer aqueous top coat material, wherein the pigmented one-layer aqueous top coat in step E1) exhibits the same spraying viscosity as the pigmented one-layer aqueous top coat applied in step D1),

F1) curing the resultant coating comprising the pigmented one-layer aqueous top coat at temperatures of e.g. below 80° C. and optionally,

G1) sanding the cured coating and polishing the sanded area.

### DETAILED DESCRIPTION OF THE EMBODIMENTS

It surprisingly has been found that optically perfect coatings are obtained with the blending-in process according to the invention, which coatings exhibit no visual differences relative to the surrounding existing coating. For example, after oven drying at forced temperatures, neither tearing of the edges of the coating nor edge marks occur.

For simplicity's sake, the pigmented one-layer aqueous top coat will be designated in short “aqueous top coat”, while two-pack should be taken to mean two-component.

The person skilled in the art knows what is meant by blending-in within the surface (=spot repair) and a blemished area within the surface (see e.g. Vehicle refinishing; Fritz Sadowski; Spies Hecker GmbH, Cologne 2000; Appendix page 389). It goes without saying that blending-in can be done, if necessary, on adjacent parts.

The individual steps of the process according to the invention are explained in greater detail below.

In the first step (step A), if necessary, the blemished area of the vehicle or vehicle part to be coated is prepared in conventional manner. The blemished area may, for example, be prepared by cleaning, sanding, recleaning and application of a putty, primer and/or primer surfacer material. The putty, primer and/or primer surfacer material may comprise conventional coating compositions that are used by the person skilled in the art, such as, putty, primer and/or primer surfacer in repair of vehicle coatings. The materials used may be solvent-based or water-based. They are cured in conventional manner. Application may, however, also be performed on a cured existing or original coating which is still intact.

The blemished area prepared in said manner, for example, the blemished area coated with a primer surfacer material and the bordering transitional zone between the blemished area and intact existing coating, is then sanded (step B) and then the sanded repair surface is optionally cleaned with conventional cleaning preparations, for example, silicone remover (step C).

Once the repair surface which has been sanded and cleaned in this manner, a solvent-based or water-based pigmented base coat is first applied onto the repair surface and faded out into the areas of the intact existing coating which border the repair surface (step D).

Then a two-pack aqueous clear coat is applied, according to the invention, onto the base coat (step E). The two-pack aqueous clear coat is applied by initially applying the prepared coating material onto the base coat area in conventional manner (step E) at conventional spraying viscosity and then by fading out into the areas of the intact existing coating which border the surface coated with the base coat (step F). The aqueous clear coat applied in step F) here exhibits the same spraying viscosity as the aqueous clear coat applied in step E). In general the same aqueous clear coat as in step E) is used. No additional thinning step is necessary. The bordering intact existing coating will here generally comprise an intact clear coating. The person skilled in the art knows how fading out into the bordering areas is to be performed in the workshop. Conventionally, for example, a reduced spray gun input pressure is used, for example, 1-2 bar. The aqueous clear coat is applied at conventional spraying viscosity, i.e. at a spraying viscosity which is familiar to the person skilled in the art of coating application and as is also specified to users in the coating suppliers' applicational data sheets. The spraying viscosity depends upon the coating material used, but is generally within a certain tolerance range which permits proper processing/application of the coating material, especially by spray application. Spraying viscosity is generally stated in seconds. In the present invention spraying viscosity is determined to DIN 53211, 4 mm/at 20° C. For clear coats, it may be, for example, 16-28 s, preferably 16-20 s.

Alternatively, as already described above, the process according to the invention may also be performed with two-pack aqueous top coats instead of the structure comprising base coat and two-pack aqueous clear coat. In this case, the two-pack aqueous top coat is applied according to the invention (step D1) onto the sanded and optionally cleaned repair surface.

The two-pack aqueous top coat is applied by initially applying the prepared coating material at conventional spraying viscosity onto the sanded and cleaned repair surface in conventional manner (step D1) and then fading out into the areas of the intact existing coating which border the repair surface (step E1). A similar procedure is here used as was described above for the application of the aqueous clear coat. The conventional spraying viscosity also corresponds to the above-stated conventional spraying viscosity. The intact existing coating in this case generally comprises an intact pigmented one-layer top coat.

Aqueous clear coats and aqueous top coats which may be used are any clear and top coats based on water-dilutable OH-functional binders and polyisocyanate crosslinking agents, as are known to the person skilled in the art of vehicle coating, in particular, vehicle repair coating.

OH-functional binders which may be considered are any polyesters, polyethers, polyurethanes and (meth)acrylic copolymers known from polyurethane chemistry, which may each be used individually or in combination with one another. The OH-functional binders may also be used in form of hybrids, e.g. as (meth)acrylated polyurethanes, (meth)acrylated polyesters or poly(meth)acrylic/polyester seed polymers. (Meth)acrylic copolymers containing hydroxyl groups, polyurethanes containing hydroxyl groups and/or acrylic/polyester hybrids containing hydroxyl groups are, however, preferably used as component C.

Preferably used (meth)acrylic copolymers containing hydroxyl groups comprise copolymers containing hydroxyl groups of free-radically polymerizable, olefinically unsaturated monomers. The copolymers have, for example, a number average molar mass (Mn) of 1,500-20,000, preferably of 1,500-10,000 g/mol, a hydroxyl value of 30-200 mg of KOH/g and an acid value of 0-100 mg of KOH/g.

Free-radically polymerizable, olefinically unsaturated monomers which may be used are monomers which, in addition to at least one olefinic double bond, also contain further functional groups and monomers which, apart from at least one olefinic double bond, contain no further functional groups. Further functional groups may be, for example, hydroxyl groups, carboxyl groups, silane groups and epoxy groups.

Polyurethanes containing hydroxyl groups which are preferably usable comprise, for example, those having a number average molar mass (Mn) of 1,000-100,000, an OH value of 10-200 mg of KOH/g and an acid value of 0-100 mg of KOH/g. The polyurethanes are produced by polyaddition from polyols and polyisocyanates. Any structural units known to the person skilled in the art may be used for the production thereof. Polyols which may, for example, be used are polyether, polyester, polycarbonate, poly(meth)acrylate and polyurethane polyols. Preferably, diols, such as, polyester diols are used. Polyisocyanates which may be considered are any desired organic polyisocyanates, preferably diisocyanates, known to the person skilled in the art having aliphatically, cycloaliphatically, araliphatically and aromatically attached free isocyanate groups.

In order to ensure sufficient water-dilutability of the hydroxy-functional binders in the aqueous coatings, the binders must be used in water-dilutable form. This may be achieved in the manner known to the person skilled in the art by ionic and/or nonionic modification of the binders. Anionic and/or nonionic modification is preferred. Anionic modification may, for example, be achieved by incorporating carboxyl groups and at least partially neutralizing them. Suitable neutralizing agents are basic compounds, such as tertiary amines, for example, triethylamine, dimethylethanolamine, and diethylethanolamine. Nonionic modification may, for example, be achieved by incorporating polyethylene oxide units. In addition to or instead of the above-stated possibilities, it is also possible to use external emulsifiers in order to ensure the required water-dilutability.

The hydroxy-functional binders may be used individually or in combination with one another.

The polyisocyanates present in the aqueous clear coats or aqueous top coats comprise any desired organic polyisocyanates having aliphatically, cycloaliphatically, araliphatically and/or aromatically attached free isocyanate groups.

The polyisocyanates are liquid at room temperature or liquefied by the addition of organic solvents. The polyisocyanates generally have a viscosity at 23° C. of from 1 to 6,000 mPas, preferably of above 5 and below 3,000 mPas.

Particularly suitable compounds are, for example, so-called “coating polyisocyanates” based on hexamethylene diisocyanate (HDI), 1-isocyanato-3,5,5-trimethyl-5-isocyanatomethylcyclohexane (IPDI) and/or bis(isocyanatocyclohexyl)methane and the per se known derivatives of said diisocyanates comprising biuret, allophanate, urethane and/or isocyanurate groups. Triisocyanates, such as, nonane triisocyanate may, however, also be used.

Sterically hindered polyisocyanates are likewise also suitable. Examples of these are 1,1,6,6-tetramethylhexamethylene diisocyanate, 1,5-dibutylpentamethyl diisocyanate, p- or m-tetramethylxylylene diisocyanate and the corresponding hydrogenated homologues.

The diisocyanates may in principle be reacted in conventional manner to yield more highly functional compounds, for example, by trimerization or by reaction with water or polyols, such as, for example, trimethylolpropane or glycerol.

The polyisocyanates may also be used in the form of isocyanate-modified resins. They may in general be used individually or in combination. These comprise the polyisocyanate crosslinking agents conventional in the coatings industry, which are comprehensively described in the literature and are also available as commercial products.

In addition to water, the aqueous clear coats and aqueous top coats may also contain small quantities of organic solvents. These comprise organic solvents typical in coatings, for example water-miscible solvents, such as, for example, alcohols or ketones.

The aqueous clear coats and aqueous top coats may contain conventional coating additives. The additives comprise the conventional additives usable in the coatings sector. Examples of such additives are light stabilizers, for example, based on benzotriazoles and HALS compounds (hindered amine light stabilizers), levelling agents based on (meth)acrylic homopolymers or silicone oils, rheological agents, such as, highly disperse silica or polymeric urea compounds, thickeners, such as, partially crosslinked polycarboxylic acid or polyurethanes, antifoaming agents, wetting agents, curing accelerators for the crosslinking reaction of the OH-functional binders with the polyisocyanates, such as, for example, organic metal salts, such as, dibutyltin dilaurate, zinc naphthenate and compounds containing tertiary amino groups, such as, triethylamine. The additives are used in conventional amounts familiar to the person skilled in the art.

The aqueous top coats additionally contain pigments. Suitable pigments are any color- and/or special effect-imparting pigments of an organic or inorganic nature that are conventional in coatings. Examples of inorganic or organic coloring pigments are titanium dioxide, micronised titanium dioxide, iron oxide pigments, carbon black, azo pigments, phthalocyanine pigments, quinacridone or pyrrolopyrrole pigments.

The aqueous clear coats and aqueous top coats used in the process, according to the invention, comprise two-component coating compositions, i.e. the hydroxy-functional component and the polyisocyanate component may be mixed with one another only shortly before application. The coating compositions may, in principle, additionally be adjusted to the required spraying viscosity with water or organic solvents before being applied.

In the process, according to the invention, the aqueous clear coats are applied onto conventional color-imparting and/or special effect-imparting solvent-based or aqueous base coats. Binder systems usable in the color-imparting and/or special effect-imparting base coats are, for example, those based on water-dilutable or solvent-dilutable polyurethane, acrylated polyurethane, polyacrylate, polyester, acrylated polyester and/or alkyd resins. The binder systems may be physically drying and/or chemically crosslinking by means of addition polymerization, polycondensation or polyaddition reactions. Preferably, they are physically drying. The coating compositions may contain further resins, for example, cellulose esters and/or melamine resins.

The aqueous clear coats are applied onto the base coat layer either after drying/curing of the base coat layer or wet-on-wet, optionally, after a flash-off phase. The clear coat is preferably applied wet-on-wet onto the base coat layer after a flash-off phase.

Curing of the clear coats may proceed at room temperature over several hours or, after a flash-off phase of for example 10-25 minutes at room temperature, be forced at higher temperatures up to, for example 80° C., preferably, 40 to 60° C., for example, within 30-80 minutes. Curing may also proceed at higher temperatures up to, for example 130° C.

After cooling and a drying phase at room temperature, for example, 40-80 minutes, or a longer drying phase of 6-12 hours, the entire coating (i.e. the blended-in area including the overspray zone) is advantageously subjected to first preliminary and then final sanding with conventional sanders, for example, eccentric sanders, and a suitable sandpaper. In this manner, the texture of the clear coating is adapted to the texture of the existing coating surrounding it. After sanding, the sanded surface is advantageously additionally polished.

The two-pack aqueous top coats which are alternatively to be used may, for example, be applied onto conventional one- or two-pack primer surfacer layers. Curing of the aqueous top coat layer may proceed similarly to the above-described curing of the aqueous clear coat layer. In this case too, sanding and polishing may advantageously subsequently be performed.

Using the process, according to the invention, it is possible to provide a very good quality blended-in finish with two-pack aqueous clear coats and two-pack aqueous top coats. Optically perfect coatings are obtained. Top coat properties are satisfactory, no edge marks occur and no reduction in gloss is observed.

The following Examples are intended to illustrate the invention in greater detail.

### EXAMPLES

A metal test sheet provided with a coating structure comprising primer surfacer, base coat and clear coat and having a blemished area of approx. 20×20 cm was blended-in according to the invention. First of all, the blemished area (intact existing primer surfacer coat) and the bordering area of the intact existing clear coat were cleaned with silicone remover, sanded and recleaned. A conventional commercial aqueous base coat (Standohyd base coat, Standox GmbH) was then applied to a dry film thickness of approx. 25 μm onto the sanded and cleaned repair area and faded out into the bordering areas of the intact existing clear coat.

After flashing-off for 20 minutes at room temperature, a conventional commercial aqueous clear coat (Standohyd two-pack clear coat+Standohyd two-pack curing agent, volume ratio 3:1, Standox GmbH) was applied onto the base coat layer to a dry film thickness of approx. 40 μm. To this end, the clear coat was adjusted with Standohyd special thinner (mixture of deionised water and water-miscible organic solvents) to a spraying viscosity of approx. 18 s/DIN 4 mm/20° C. Application was carried out with a SATA mini jet SR 1.2 spray gun with a spray gun inlet pressure of approx. 1.5 bar. Fading out into the bordering areas of the intact existing clear coat was performed. Fading out was performed using the same clear coat material of the same spraying viscosity as was used for application to the actual repair area.

After a flashing-off for 25 minutes at room temperature, the coating was cured for 40 minutes at 60° C. After cooling and a drying phase of 12 hours at room temperature, the blended-in area including the transition zone was subjected to sanding with a conventional (eccentric) sander, initially with Mirka Abralon P2000 sandpaper and then with Mirka Abralon P4000 sandpaper. The sanded area was then polished in succession with coarse rubbing compound 09591 (3M), Perfect it 09547 rubbing compound (3M), Perfect it 09548 high gloss polish (3M) and high gloss sealant 09549 (3M).

### COMPARATIVE EXAMPLE

For purposes of comparison, a blemished area prepared as described above was conventionally blended-in using the method hitherto conventional in the prior art for solvent-based clear coats. The following method was used:

As described above, after flashing-off for 20 minutes at room temperature, a conventional commercial aqueous clear coat (Standohyd two-pack clear coat+Standohyd two-pack curing agent, volume ratio 3:1, Standox GmbH) was applied onto the base coat layer to a dry film thickness of approx. 40 μm. Application was carried out with a SATA mini jet SR 1.2 spray gun with a spray gun inlet pressure of 1.5 bar. Fading out into the bordering area of the intact existing clear coat was performed with further thinned clear coat material and a spray gun pressure of approx. 1.5 bar. To this end, 1 part by volume of aqueous clear coat was mixed with 5 parts by volume of Standohyd special thinner. After a flashing-off for 25 minutes at room temperature, the coating was cured for 40 minutes at 60° C. After cooling and a drying phase of 12 hours at room temperature, the blended-in area was sanded and polished as described above.

Summary of Results

The aqueous clear coat applied, according to the invention, exhibited very smooth flow in the spreading and mist zones. No edge marks could be seen in the transitional zone between the existing coating and repair coating. Top coat properties were satisfactory.

The blending-in result corresponded to a good blending-in result as can be achieved with conventional solvent-based two-pack clear coats.

Application of the aqueous clear coat in the comparative test gave rise to unsatisfactory top coat properties. Slight microtexture and edge marks were visible. A lower gloss was observed in the comparative test and in addition a reduction in gloss was observed some time after polishing.

| | |
|---|---|
| | Comparative |
| Example | Example |

according to the invention

| Gloss values (1)* | 20° | 60° | 20° | 60° |
|---|---|---|---|---|
| Immediately after polishing | 84 | 90 | 77 | 88 |
| 24 h after polishing | 84 | 90 | 74 | 86 |
| 48 h after polishing | 84 | 90 | 74 | 85 |

*measured with a measuring instrument according to standards ISO 2813, ASTM D523

We claim:

1. A process for repairing a multi-layer coating of a substrate having at least one blemished area within a surface of the coating, wherein repair of the coating is performed with an aqueous clear coat by means of blending-in within the surface, wherein the process comprises the following successive steps:
A) optionally, preparing the blemished area on the substrate to be coated in conventional manner,
B) sanding the blemished area and the transitional zone between the blemished area and intact existing coating,
C) optionally, cleaning the sanded repair surface,
D) applying a pigmented base coat onto the sanded and cleaned repair surface and fading out into the areas of the intact existing coating, which border the repair surface, with the base coat,
E) applying a two-component aqueous clear coat based on an OH-functional binder and a polyisocyanate crosslinking agent having free isocyanate groups at conventional spraying viscosity onto the base coat,
F) fading out into the areas of the intact existing coating, which border the surface coated with the base coat, with the aqueous clear coat material, wherein the aqueous clear coat in step F) exhibits the same spraying viscosity as the aqueous clear coat applied in step E),
G) curing the resultant coating comprising base coat and clear coat and optionally,
H) sanding the cured coating and polishing the sanded area.

2. A process for repairing a multi-layer coating of a substrate having at least one blemished area within a surface of the coating, wherein repair of the coating is performed with an aqueous pigmented coat by means of blending-in within the surface, wherein the process comprises the following successive steps:
A) optionally, preparing the blemished area on the substrate to be coated in conventional manner,
B) sanding the blemished area and the transitional zone between the blemished area and intact existing coating,
C) optionally, cleaning the sanded repair surface
D1) applying a pigmented, two-component one-layer aqueous top coat based on an OH-functional binder and a polyisocyanate crosslinking agent having free isocyanate groups at conventional spraying viscosity onto the sanded and cleaned repair surface,
E1) fading out into the areas of the intact existing coating, which border the repair surface, with the one-layer aqueous top coat material, wherein the one-layer aqueous top coat in step E1) exhibits the same spraying viscosity as the one-layer aqueous top coat applied in step D1),
F1) curing the resultant coating comprising the one-layer aqueous top coat and optionally,
G1) sanding the cured coating and polishing the sanded area.

3. The process according to claim 1, wherein curing in step G) proceeds at temperatures of below 80° C.

4. The process according to claim 1, wherein curing in step G) proceeds at temperatures of 20-60° C.

5. The process according to claim 1, wherein the OH-functional binders selected from the group consisting of OH-functional polyurethanes, OH-functional poly(meth)acrylates and OH-functional poly(meth)acrylate/polyester hybrids.

6. The process, according to claim 1, wherein an aqueous base coat is applied in step D).

7. The process, according to claim 1, wherein a physically drying base coat is applied in step D).

8. The process according to claim 1, wherein the aqueous clear coat is applied at a spraying viscosity of 16-28 s/4 mm/20° C.

9. The process according to claim 7, wherein the aqueous clear coat is applied at a spraying viscosity of 16-20 s/4 mm/20° C.

10. The process according to claim 2, wherein curing in step F1) proceeds at temperatures of below 80° C.

11. The process according to claim 2, wherein curing in step F1) proceeds at temperatures of 20-60° C.

12. The process according to claim 2, wherein the OH-functional binders selected from the group consisting of OH-functional polyurethanes, OH-functional poly(meth)acrylates and OH-functional poly(meth)acrylate/polyester hybrids.

13. The process according to claim 2, wherein the one-layer aqueous top coat is applied onto a primer surfacer layer.

14. The process according to claim 2, wherein the aqueous pigmented one-layer top coat is applied at a spraying viscosity of 16-28 s/4 mm/20° C.

15. The process, according to claim 12, wherein the aqueous pigmented one-layer top coat is applied at a spraying viscosity of 16-20 s/4 mm/20° C.

16. The process according to claim 1, wherein the substrate comprises vehicles.

17. The process according to claim 2, wherein the substrate comprises vehicles.
